(19) United States
(12) Patent Application Publication
(10) Pub. No.: US 2018/0375901 A1
(43) Pub. Date: Dec. 27, 2018

(54) METHOD OF COMMUNICATION BETWEEN A CALLING TERMINAL AND A PLURALITY OF CALLED TERMINALS

(71) Applicant: Orange, Paris (FR)

(72) Inventors: José Doree, Lannion (FR); Jean-Claude Le Rouzic, Trebeurden (FR)

(21) Appl. No.: 16/063,143

(22) PCT Filed: Dec. 14, 2016
(86) PCT No.: PCT/FR2016/053439

§ 371 Date: Jun. 15, 2018

(30) Foreign Application Priority Data
Dec. 18, 2015 (FR) 1562866

(51) Int. Cl. H04L 29/06

(52) U.S. Cl. CPC H04L 65/105; H04L 65/1006; H04L 65/1096; H04L 65/1073; H04L 65/1016

(57) ABSTRACT

A method is provided of communication between a first user of an IP (Internet protocol) network and a second user of the IP network, the second user having a plurality of client devices connected to the IP network. A client device of the first user sends a request to the second user, and a proxy server of the second user sends the request to all the client devices of the second user. At least one of the client devices of the second user sends a response to the request from the first user, and each of the responses is intercepted by the proxy server. The proxy server sends each of the responses to the first user, without waiting for other possible responses, after having inserted at least the following information therein: an indication of the total number of client devices of the second user to whom the request was sent, and an indication of the number of responses sent thus far by one or more client devices of the second user.

The present invention relates to communications networks of the Internet Protocol (IP) type, and in particular to those IP networks that are suitable for implementing advanced session initiation protocols. IP networks enable speech data to be transmitted in the context of services such as voice over IP (VoIP), content sharing, or instant messaging.

More particularly, the present invention relates to the means put into place in an IP network in order to enable a sender of a request to know which user devices of the callee to whom the request was sent have indeed received the request.

By way of example, such user devices may be a fixed or mobile terminal, or a gateway that may be residential or else situated in a business. For reasons of brevity, the generic term “user terminal” or just “terminal” for short, is used below to designate such various pieces of equipment.

Communication services on an IP network can identify physical or virtual resources by means of character strings such as a uniform resource identifier (URI). The syntax of URIs is defined in IETF Document RFC 3986; knowing the URI of a resource makes it possible to obtain the IP address of a piece of equipment in the network of the operator managing that resource. In the present description, the term “URI” is used to designate any type of identifier for a physical or virtual application resource that is accessible on the network.

Conventional advanced session control protocols, such as session initiation protocol (SIP) make use of so-called “signaling” messages, which are messages that enable a terminal to request a connection with another terminal, or likewise messages signaling that a telephone line is busy, or signaling that the called telephone is ringing, or indeed signaling that a particular telephone is connected to the network and can be reached in such-and-such a manner.

The SIP protocol was originally defined by the Internet engineering task force (IETF) in Document RFC 3261. That protocol makes it possible to set up, to modify, and to terminate multimedia sessions in a network using the IP protocol. The SIP protocol has subsequently been extended, in particular in Document RFC 3265. This extension defines procedures for notifying events.

The SIP protocol is used in particular in IP multimedia subsystem (IMS) type infrastructures. The IMS was defined by the third generation partnership project (3GPP) and the telecommunications and Internet converged services and protocols for advanced networking (TISPAN) standards organization. It is a network architecture that was introduced by the 3GPP for mobile networks, and then taken up by TISPAN for fixed networks. That architecture enables multimedia sessions to be set up dynamically and controlled between two clients, and it also enables resources to be reserved at network level for transporting multimedia streams. This architecture provides network operators with convenient means for implementing a management policy, for providing a determined quality of service (QoS), and for calculating amounts to bill clients. At present, the IMS makes it possible to access services involving telephony, videophone, presence, and instant messaging, and it also manages interactions between those services.

Each user of an IMS network may be identified therein by means of various identities, in particular an IP multimedia private identity (IMPI) and an IP multimedia public identity (IMPU).

IMPI is defined in 3GPP Specification TS 23.228. An IMPI is an identity that is allocated on a permanent basis by the operator of a network to a subscription with that operator, and by way of example it is used for registering, authorizing access, administering services made available to the user, and billing (it should be observed that a user may have a plurality of IMPIs within a single subscription; each IMPI can thus be associated with a different client-device). An IMPI is in the form of a network access identifier (NAI), as defined in IETF Document RFC 4282.

A user makes use of an IMPU in order to communicate with other users. An IMPU is in the form of a URI or a short number, or indeed an alias. For a given IMPI, there may be a plurality of IMPUs (often a tel-URI and an SIP-URI). An IMPU may be shared with another telephone, so that both telephones can be reached using the same identity (e.g. a single telephone number for an entire family of users). These identities are configured by the operator when a user creates an account with that operator, and they are used when registering any of the user's devices with the network.

Thus, when a user seeks to benefit from services made available by an IMS network, the user sends signaling messages to the network, which messages may include in particular various types of request.

Firstly, the user's device needs to register with the network (ignoring certain exceptions such as certain emergency calls). When the network is incapable of associating the registration with an earlier registration (e.g. following a network failure, or following the user device being turned off for a duration longer than a predetermined value), the registration is considered as being an initial registration. After an initial registration, the user's device needs to send a request periodically to the network in order to confirm that it seeks to maintain its registration.

In order to register user devices, IMS networks have one or more registration servers known as serving call server control function (S-CSCF) servers that are suitable (among other functions) for managing the procedure for registering devices connected to the network.

IMS networks also include one or more interrogation servers known as interrogating-call server control function (I-CSCF) servers, which are often physically combined with S-CSCF registration servers so as to constitute servers that are referenced “I/S-CSCF”, and that, at the time a user device is being registered, interrogate a subscriber data server known as a home subscriber server (HSS) in order to be able to select an S-CSCF server that possesses the characteristics that are required (either necessarily or in some circumstances optionally) for achieving the level of service to which the subscriber has subscribed. Each HSS server has a client database and is thus the equivalent in an IP network of a home location register (HLR) as is used in GSM networks. Each HSS server contains the “profile” of a certain number of user devices of the network, which profile contains their registration status, authentication and location data, and the services to which they are entitled.

Specifically, after an S-CSCF server has been allocated to a user, that user can make use of a certain number of services during a current session. For example, these may be services that are made available automatically to all users of the IMS network. These may equally well be services to which the user has taken out a subscription with the network operator, and which are made available to the user automatically. Finally, they may be services that the user can use after sending an appropriate request (SIP SUBSCRIBE).

These services comprise audiovisual applications as mentioned above. They may also involve a subscription to the status of a resource, in which case event notifications (SIP NOTIFY) are sent to the user device as soon as the status of the resource changes; for example, when the user of a user device has a voice message box on the network, the user may be informed on each occasion that a message is stored in the voice message box; the user can likewise ask to be notified about the registration status of any of the user's own user devices.

IMS networks also include one or more services referred to as proxy-call server control function (P-CSCF) servers. For each user device connected to an IMS network, there exists a P-CSCF server acting as the connection entity between the IMS core network and the access network used by the user device; thus, all of the SIP signaling exchanged between the user device at one end and the I-CSCF interrogation server or the S-CSCF registration server at the other end passes via the P-CSCF server.

When a first user (referred to as the “caller”) issues a request addressed to a second user (referred to as the “callee”), the caller does not as a general rule know the capabilities of the callee's terminal, or the capabilities of the callee's terminals when the callee possesses a plurality of terminals (each of these terminals is usually associated with a respective IMPI, while sharing a single common IMPU). The term “capabilities” of a terminal is used in the context of the present invention to designate the technical capabilities of the terminal for participating in providing a particular service, e.g. a telephone service, or a high definition (HD) voice service, or a video service, or indeed an instant messaging service.

However, having knowledge of these technical capabilities would be very useful to the caller, since it would enable the caller to know:

1) whether one of the callee's terminals possesses sufficient capabilities for the service desired by the caller; and

2) if such a terminal exists, the identity of that terminal or how it can be reached.

For example, assume that a caller issues an SIP MESSAGE request (which in compliance with IETF Document RFC 3428 proposes an instant messaging exchange). If the callee possesses a plurality of terminals that are connected at that moment to the IP network, and if one of those terminals also possesses, in addition to the capability of exchanging instant messaging, the capability of transferring http files, it would be very useful for the caller to be informed of that capability since such a file transfer may be desirable later on in the session.

Various proposals are known in the state of the art seeking to solve that problem.

In particular, solutions are known that are based on “applications servers” that aggregate the capabilities of each of the connected terminals of a user. However those solutions do not represent the capabilities of each of the terminals connected at a given instant, since it is the aggregate of the capabilities of all of the terminals that is given and not the individual capabilities of each of those terminals.

Other solutions, based on “forking”, i.e. on transmitting a single control signal to a plurality of destination terminals (as described in 3GPP standards Series 6), make it possible to explore the capabilities of at least some of the connected terminals by sending them a dedicated request. It should be recalled in this respect (cf. Section § 16.5 of above-mentioned Document RFC 3261, and Section § 7 of IETF Document RFC 3841) that two forking procedures exist, one referred to as “parallel” forking and the other as “sequential” forking, depending on the order in which said control signal is transmitted to said destination terminals.

By way of example, application US 2011/314140 proposes a method of processing a capability request in an IMS network. In that method, a proxy server receives from a “caller” an SIP OPTIONS message for a “callee” (according to above-mentioned Document RFC 3261, an SIP OPTIONS request enables an SIP agent to request another SIP agent to give it its capabilities). The proxy server forwards the request to a plurality of terminals of said callee, and receives a response (SIP 200 OK) from at least one of those terminals. Each received response, which includes an identity of the responding terminal together with an indication of the capabilities of the responding terminal, is stored. Thereafter, the proxy server prepares a response message containing the identities and the capabilities of all of the responding terminals. Finally, the response message is sent to the caller. That method thus complies with Sections 11.2 and 16.7 of above-mentioned Document RFC 3261, which sections specify that a proxy server that has performed forking may send only one SIP 200 OK response to a caller.

Nevertheless, the method according to application US 2011/314140 presents several drawbacks.

A first drawback is that the procedure for temporarily aggregating and storing responses in a proxy server requires considerable resources.

A second drawback is that the method imposes a considerable delay on the caller before receiving the requested capabilities.

A third drawback is that the caller has no guarantee that all of the terminals of the callee that are connected to the IP network have received the request (and have therefore responded with an SIP 200 OK message). By way of example, this problem is particularly acute when a caller issues an SIP OPTIONS request or an SIP INFO request in order to determine the number of callee terminals and their characteristics; by way of example, this mechanism is used for rich communication suite (RCS) services. In another example, the problem also arises acutely when a caller seeks to broadcast certain information to all of the connected terminals of a certain callee, e.g. in order to use an SIP MESSAGE request to send an alert message to all of those terminals, or to use an SIP SUBSCRIBE message to subscribe to a particular event (e.g. geolocation or presence) concerning all of those terminals.

In a first aspect, the present invention thus relates to a method of communication between a first user of an Internet Protocol (IP) network and a second user of said IP network, said method comprising the following steps when said second user has a plurality of user devices connected to the IP network:

a) a user device of said first user issues a request to said second user;

b) a proxy server of said second user performs a so-called “forking” procedure that consists in relaying said request to all of said user devices of the second user;

c) at least one of the user devices of the second user issues a response to the request from the first user; and

d) each of said responses is intercepted by said proxy server.

Said method is remarkable in that it further comprises the following step:

e) the proxy server forwarding each of said responses to the first user without waiting for any possible other responses, after inserting therein at least the following information:
an explicit or implicit indication of the total number of user devices of the second user to which the request was forwarded during step b); and
an explicit or implicit indication of the number of responses issued so far by one or more user devices of the second user.

By means of these provisions, the first user is rapidly in a position to know which user devices of the second user have indeed received the request. Furthermore, since (in conventional manner) each response contains a unique identifier of the responding user device (e.g. in the SIP protocol, the “sip.instance” parameter as defined in IETF Document RFC 5626 or the GRUU resource identifier defined in IETF Document RFC 5627), the first user can then (if so desired) send a message to such and such a specified one of the user devices of the second user.

According to particular characteristics, said information inserted in a given response also includes the order in which the forking was performed to the user devices of the second user in terms of parallel forking and/or sequential forking.

By means of these provisions, after receiving the first response, the caller can estimate the length of time it will be necessary to wait before receiving the other responses. Specifically, as is known to the person skilled in the art, sequential forking takes longer than parallel forking.

According to even more particular characteristics, said information inserted in a given response also includes the order of the responses issued so far by one or more user devices of the second user, in terms of parallel forking and/or sequential forking.

According to other even more particular characteristics, said information inserted in a given response also includes the order in which said forking to the user devices of the second user was performed, in terms of unique identifiers of the user devices.

In a second aspect, the invention relates to various devices.

Thus, it relates firstly to a proxy server in an Internet Protocol (IP) network and comprising means for:
receiving a request issued by a user device of a first user of said IP network to a second user of the IP network;
when said second user has a plurality of user devices connected to the IP network, implementing a so-called “forking” procedure consisting in forwarding said request to all of the user devices of the second user; and
intercepting each response to the request of the first user as issued by a user device of the second user. Said proxy server is remarkable in that it further comprises means for forwarding each of said responses to the first user without waiting for possible other responses, after inserting therein at least the following information:
an explicit or implicit indication of the total number of user devices of the second user to which the request was forwarded during said forking procedure; and
an explicit or implicit indication of the number of responses issued so far by one or more user devices of the second user.

According to particular characteristics, said information inserted in a given response also includes the order in which the forking was performed to the user devices of the second user in terms of parallel forking and/or sequential forking.

According to even more particular characteristics, said information inserted in a given response also includes the order of the responses issued so far by one or more user devices of the second user, in terms of parallel forking and/or sequential forking.

According to other even more particular characteristics, said information inserted in a given response also includes the order in which the forking to the user devices of the second user was performed, in terms of unique identifiers of the user devices, the unique identifier of each of the user devices being supplied by the user device to the proxy server, or being constructed for the user device by the proxy server.

According to other particular characteristics, said proxy server further comprises means for inserting said information in said responses only when it observes that said request received from the first user includes a dedicated indicator in a dedicated header.

Secondly, the invention also provides a user device of a user, referred to as the “first” user, of an Internet Protocol (IP) network and comprising means for:
issuing a request to a second user of said IP network; and
receiving a response to said request from at least one of the user devices of the second user that is connected to the IP network.

Said user device is remarkable in that it further comprises means for taking account in said response of at least the following information:
an explicit or implicit indication of the total number of user devices of the second user to which the request was transmitted in compliance with a so-called “forking” procedure; and
an explicit or implicit indication of the number of responses issued so far by one or more user devices of the second user.

According to particular characteristics, said information taken into account in a given response also includes the order in which the forking was performed to the user devices of the second user in terms of parallel forking and/or sequential forking.

According to even more particular characteristics, said information taken into account in a given response also includes the order of the responses issued so far by the user devices of the second user, in terms of parallel forking and/or sequential forking.

According to other even more particular characteristics, said information taken into account in a given response also includes the order in which said forking to the user devices of the second user was performed, in terms of unique identifiers of the user devices.

According to other particular characteristics, said user device further comprises means for inserting in said request a dedicated indicator in a dedicated header, said dedicated indicator indicating that the user device includes said means for taking account of said information.

Thirdly, the invention also relates to a stateful server. Said stateful server is remarkable in that it comprises means for acting when it is placed on the signaling path between the user device of a first user and the proxy server in charge of a second user of an IP network, to:
transfer a request issued by said user device of the first user to said proxy server in charge of the second user; and
transfer to the user device of the first user a plurality of respective responses to said request issued by a plurality of respective user devices of the second user.

Specifically, in conventional manner (cf. Sections 16.2 and 17 of above-mentioned Document RFC 3261), certain nodes situated on the signaling path between a first user and a second user of an IP network are suitable for following the progress of the processing of a request issued by the first user for the second user: such nodes are referred to as “stateful” servers. However, although this is not required by Document RFC 3261 or by any standard, stateful servers are usually configured in compliance with Sections 11.2 and 16.7 of the above-mentioned document, i.e. they cannot transmit to the first user more than one response issued by the second user. That is why, in order to enable the present invention to be performed, stateful servers situated on the signaling path between the first user and the server in charge of forking for the second user need to be configured so as to pass a plurality of responses to a request, where applicable.

The advantages made available by these devices are essentially the same as those made available by the corresponding methods set out briefly above.

It should be observed that it is possible to implement such devices in the context of software instructions and/or in the context of electronic circuits.

In a third aspect, the invention provides a communication system in an Internet Protocol (IP) network comprising at least one proxy server as described briefly above and at least one node as described briefly above.

The invention also provides a computer program downloadable from a communications network and/or stored on a computer readable medium and/or executable by a microprocessor. The computer program is remarkable in that it includes instructions for executing steps of the method of communication set out briefly above, when it is executed on a computer.

The advantages made available by the computer program are essentially the same as those made available by said method.

Other aspects and advantages of the invention appear on reading the following detailed description of particular embodiments, given as non-limiting examples. The description refers to the accompanying figures, in which:

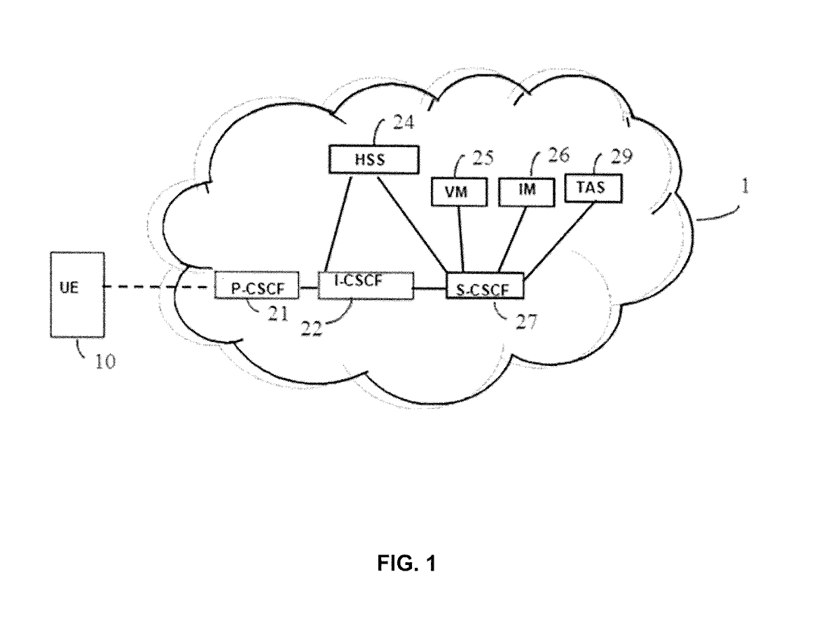

FIG. 1 is a diagram showing a system for providing multimedia services that is suitable for performing the invention;

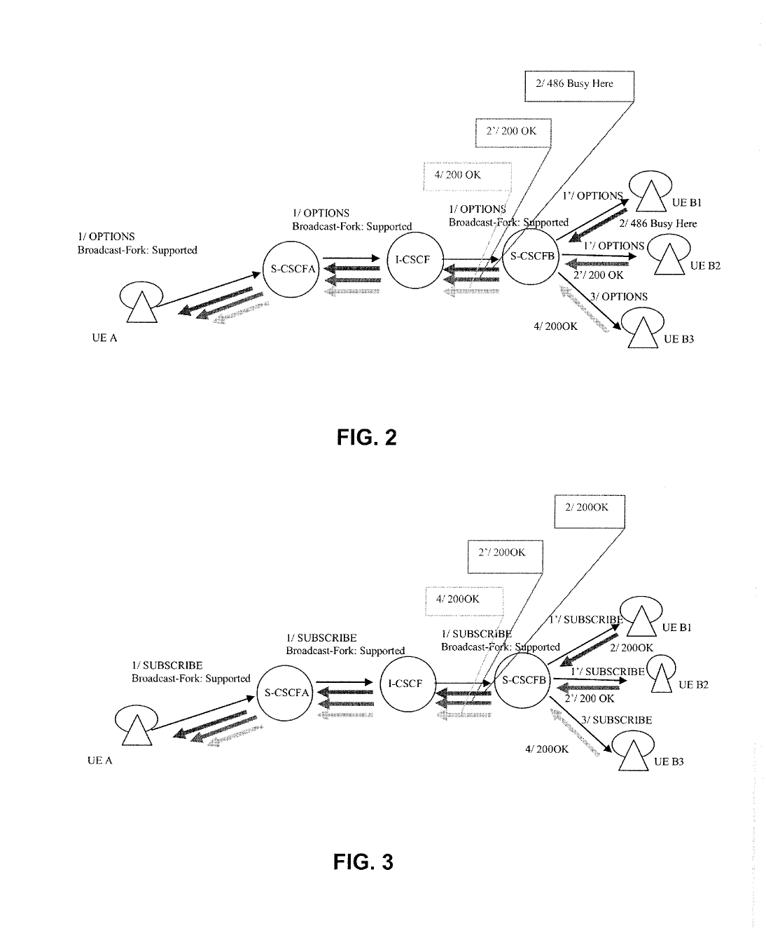

FIG. 2 shows a first implementation of the invention in which a user of an IMS IP network issues an OPTIONS request; and

FIG. 3 shows a second implementation of the invention in which a user of an IMS IP network issues a SUBSCRIBE request.

Although the present invention relates to IP networks in general, consideration is given below by way of example of implementation to a network architecture of the IMS type, as described briefly below. This architecture is shown in FIG. 1.

The multimedia services made available by this IMS network 1 may comprise telephony, video-telephony, content sharing, presence, instant messaging, or television services. These services are available to the user of a user device (also known as “user equipment” or (UE)) 10 belonging to the network 1, enabling the user device 10 to exchange multimedia streams and session control signals in compliance with the SIP protocol, e.g. with the user device (not shown) of a user belonging to an SIP network (not shown) connected to the network 1.

The user device 10 may be a fixed or mobile terminal, or a residential or business gateway, having SIP signaling means and possibly including means for playing audiovisual content.

As shown in FIG. 1, the IMS network 1 comprises, in addition to its IP transport infrastructure (not shown), the following:
at least one S-CSCF server; the S-CSCF server 27 serves in particular to manage the procedure for registering devices connected to the network 1; the S-CSCF server 27 also manages routing signaling between the user device 10 and the voice messaging (VM) servers 25, instant messaging (IM) servers 26, and telephony servers (TAS) 29;
at least one I-CSCF server; the I-CSCF server 22 serves in particular to manage routing to other terminals managed by the same IMS network 1 and routing signaling between the IMS network 1 and other networks (not shown);
at least one P-CSCF server; the P-CSCF server 21 serves as a connection entity between the IMS core network and the access network used by the user device 10;
at least one database server of the HSS type; the HSS server 24 contains the user profile of the user device 10 in terms of authentication and location data and of subscribed services;
at least one voice messaging (VM) server 25; the VM server 25 manages the subscription of the user device 10 to events relating to leaving and/or consulting messages for the user device 10 and notifies the user device 10 when such events occur with a “message-summary”;
at least one instant messaging (IM) server 26; if the user of the user device 10 has subscribed to the instant messaging service, the user can have “instant” on-line dialog with other subscribers to that service; and
at least one telephony application server (TAS) 29; the TAS server manages the telephony services to which the user of the terminal 10 has subscribed with the operator, such as number presentation or call forwarding.

The VM voice messaging servers 25, the IM instant messaging servers 26, and the TAS telephony application servers 29 are all examples of applications servers (AS).

Certain services, such as those of the VM server 25 and those of the IM instant messaging server 26 rely on the terminal 10 subscribing to predetermined events, as explained above.

There follows a description of various implementations of the invention in which it is assumed that a user A of an IMS network issues a request to another user B of the same IMS network.

In the context of a first example, shown in FIG. 2, the following steps are performed in a first implementation.

During a step E1, the user A issues an OPTIONS request to the user B. This request contains a header dedicated to performing the present invention, which is referred to herein as a “Broadcast-Fork”; specifically, this header contains the mention “supported”, indicating the user A is capable of performing the invention. Furthermore, the user A may optionally indicate in the request (e.g. by means of a “request-disposition: parallel” header) that the user desires the forking performed by the proxy server of user B to be specifically a parallel forking (since that is faster than sequential forking).

During a step E2, the OPTIONS request passes conventionally to B's S-CSCF server.

During a step E3, the S-CSCF server of the user B performs (in conventional manner) a procedure for forking to all of B's connected terminals, namely the terminals B1, B2, and B3. More precisely, it is assumed in this example that the user A has not declared any preference and that the S-CSCF server of the user B performs parallel forking to the terminals B1 and B2 (arrows “1′/OPTIONS” in FIG. 2), followed by sequential forking to the terminal B3 (arrow “3/OPTIONS” in FIG. 2).

During a step E4, each of these terminals issues a respective response to the OPTIONS request containing its respective technical capabilities; for example, the response of terminal B1 is constituted by a “486 Busy” signal (represented by “2/” in the figure), the response of the terminal B2 is constituted by a “200 OK” signal (designated by “2′/” in FIG. 2), and the response of the terminal B3 is likewise constituted by a “200 OK” signal (designated by “4/” in FIG. 2).

During a step E5, the S-CSCF server of user B intercepts said responses.

During a step E6, the S-CSCF server of user B once more takes account of the “supported” indication in the Broadcast-Fork header of the request issued by user A, and causes each response to be forwarded to user A after enriching that response and without waiting for possible other responses. It should be observed that this behavior of the S-CSCF server (or more generally of any proxy server of the invention) differs from conventional behavior, in which (as mentioned above) a proxy server sends only one (200 OK) response to the issuer of a request, and does so regardless of the number of destination terminals that have responded to the request.

In the present implementation, each response respectively received by the S-CSCF from a terminal of the user B is enriched by inserting the following information, e.g. in the Broadcast-Fork header:
where applicable, a “required” indication to confirm to user A that the forking request has indeed been taken into account;
optionally, an explicit indication of the total number of terminals of user B involved in the forking;
a first mention giving the order in which the forking was performed; and
a second mention giving the order of the responses received so far by the S-CSCF server relating to the forking that was performed.

In the example under consideration:
the total number of terminals is: “count=3”;
said first mention is of the type:
“fork: parallel=2, sequential=1”
   (i.e. parallel forking to two terminals followed by sequential forking to the third terminal); and
said second mention is of the type:
   in the response from terminal B1: “response: parallel=1” (implying that only one response has been received so far by the S-CSCF server from user B);
   in the response from terminal B2: “response: parallel=2” (implying that two responses has been received so far); and
   in the response from terminal B3: “response: parallel=2, sequential=1” (implying that all three responses have been received).

Finally, during a step E7, the user A receives the enriched responses.

The user A is thus quickly in a position to verify that all of the terminals of user B have indeed received the OPTIONS request (three responses received for three forking targets). Furthermore, after receiving the response from terminal B3, the user A can observe that the transaction has terminated (whereas in the prior art that observation was based on receiving a single 200 OK response). Finally, where necessary, the user A can take cognizance of the technical capabilities of each of those terminals.

In the context of a second example, shown in FIG. 3, the following steps are performed, still in the first implementation.

During a step E′1, the user A sends a SUBSCRIBE request to the user B. For example, the user A may subscribe to a presence notification service. Advantageously, sending a single request makes it possible to subscribe simultaneously to all events of all of B's terminals.

In a manner analogous to the first example, this first SUBSCRIBE request contains:
a “Broadcast-Fork” header of the invention, this header containing the mention “supported” to indicate that A is capable of performing the invention; and
optionally, a “Request-Disposition: parallel” header indicating that the user A desires the proxy server of user B to perform parallel forking.

During a step E′2, the SUBSCRIBE request passes conventionally to B's S-CSCF server.

During a step E′3, the S-CSCF server of user B performs a forking procedure to all of B's connected terminals, namely to the terminals B1, B2, and B3. It is assumed once more in this example that the S-CSCF server of user B performs parallel forking to the terminals B1 and B2 (arrows “1′/SUBSCRIBE” in FIG. 3), followed by sequential forking to the terminal B3 (arrow “3/SUBSCRIBE” in FIG. 3).

During a step E′4, each of these three terminals issues a response to the SUBSCRIBE request; by way of example, these responses are constituted by “200 OK” signals (designates by “2/”, “2′/”, and “4/” in FIG. 3).

The steps E′5, E′6, and E′7 are analogous respectively to the steps E5, E6, and E7 described above with reference to the first example.

The user A is thus rapidly in a position to verify that all of the terminals of the user B have indeed received the SUBSCRIBE request (three responses received for three forking targets), and consequently that the user A is indeed benefiting from a subscription to each of those terminals.

In a second implementation, each response respectively received by the S-CSCF from a terminal of the user B is enriched by inserting the following information, e.g. in a “Broadcast-Fork” header:
where appropriate, a “required” indicator for confirming to the user A that the forking request has indeed been taken into account;
optionally, an explicit indication of the total number of terminals of the user B involved in the forking; and
a mention giving the order in which the forking was performed, enriched with the unique identifier of each of the terminals.

This unique identifier as inserted by the S-CSCF in the response is preferably the identifier supplied by the terminal itself (e.g. in the SIP protocol the sip.instance parameter or the above-mentioned resource identifier GRUU) during its own registration with the network; if the terminal does not provide any unique identifier, then the unique identifier inserted by the S-CSCF in the response may be constructed for that terminal by the S-CSCF, in accordance with a particular characteristic of the present invention.

Thus, in the context of examples analogous to the examples described above with reference to the first implementation:
the total number of terminals is “count=3”; and
said mention is of the following type: “fork: parallel=2, sip.instance=UE1, sip.instance=UE2; sequential=1, sip.instance=UE3”.

Thus, by comparing with the unique identifiers of the terminals in the forking order, the user A can determine which terminal responded last, and in particular can discover whether any one of those terminals is no longer connected to the network.

It should be observed that in the implementations described above, the information concerning the capability of the user A to perform the invention, and the information inserted by the S-CSCF server of the user B in the response(s) from the terminals of the user B are conveyed in a dedicated header (Broadcast-Fork). However other formats are naturally possible for conveying these various items of information. Thus, in a variant, the information may be conveyed in the message body (or “body xml”) of the request issued by the user A and/or of the response(s) to that request.

In general manner, the present invention may be performed within nodes of an IP network, e.g. proxy servers, user devices, or stateful servers, by means of software and/or hardware components.

The software components are integrated in a conventional computer program for managing a network node. That is why, as mentioned above, the invention also provides a computer system. In conventional manner, the computer system has a central processor unit using signals to control a memory and an input unit and an output unit. Furthermore, the computer system may be used for executing a computer program including instructions for performing any of the methods of communication of the invention.

Specifically, the invention also provides a computer program that is downloadable from a communications network and that comprises instructions for executing steps of a method of communication of the invention when executed on a computer. The computer program may be stored on a computer-readable medium and may be executable by a microprocessor.

The program may also use any programming language and be in the form of source code, object code, or code intermediate between source code and object code, such as in a partially compiled form or in any other describe form.

The invention also provides a non-removable or partially or totally removable data medium that is readable by a computer and that includes instructions of a computer program as mentioned above.

The data medium may be any entity or device capable of storing the program. For example, the medium may comprise storage means such as a read only memory (ROM), e.g. a compact disk (CD) ROM, or a microelectronic circuit ROM, or magnetic recording means, such as a hard disk, or indeed a universal serial bus (USB) flash drive.

Furthermore, the data medium may be a transmissible medium such as an electrical or optical signal, suitable for being conveyed via an electrical or optical cable, by radio, or by other means. The computer program of the invention may in particular be downloaded from an Internet type network.

In a variant, the data medium may be an integrated circuit in which the program is incorporated, the circuit being adapted to execute or to be used in the execution of any of the methods of communication of the invention.

1-19. (canceled)

20. A method of communication between a first user of an Internet Protocol (IP) network and a second user of said IP network, the second user having a plurality of user devices connected to the IP network, said method performed by a proxy server of said second user and comprising:
performing a forking procedure comprising relaying a request issued by a user device of a first server to all of the plurality of user devices of the second user;
intercepting, by said proxy server, one or more responses to the request from the first user, each response of the one or more responses issued by one of the plurality of user devices; and
forwarding each of said one or more responses to the first user without waiting for any possible other responses, after inserting therein at least the following information:
an explicit or implicit indication of the total number of user devices of the second user to which the request was forwarded; and
an explicit or implicit indication of the number of responses issued so far by one or more user devices of the second user.

21. The method of claim 20, wherein the information inserted in a given response also includes the order in which the request was relayed in the forking procedure to the plurality of user devices of the second user in terms of parallel forking and/or sequential forking.

22. The method of claim 21, wherein the information inserted in a given response also includes the order of the responses issued so far by user devices of the second user, in terms of parallel forking and/or sequential forking.

23. The method of claim 21, wherein the information inserted in a given response also includes the order in which the request was relayed to the plurality of user devices of the second user in the forking procedure, in terms of unique identifiers of the user devices.

24. A proxy server in an Internet Protocol (IP) network the proxy server configured to execute software to:
receive a request issued by a user device of a first user of said IP network to a second user of the IP network, the second user having a plurality of user devices connected to the IP network
implement a forking procedure comprising forwarding said request to all of the plurality of user devices of the second user; and
intercept each response to the request of the first user as issued by a user device of the second user; and
forward each of said intercepted responses to the first user without waiting for possible other responses, after inserting therein at least the following information:
an explicit or implicit indication of the total number of user devices of the second user to which the request was forwarded during said forking procedure; and
an explicit or implicit indication of the number of responses issued so far by one or more of the plurality of user devices of the second user.

25. The proxy server of claim 24, wherein the information inserted in a given response also includes the order in which the request was relayed in the forking procedure to the plurality of user devices of the second user in terms of parallel forking and/or sequential forking.

26. The proxy server of claim 25, wherein the information inserted in a given response also includes the order of the responses issued so far by user devices of the second user, in terms of parallel forking and/or sequential forking.

27. The proxy server of claim 25, wherein the information inserted in a given response also includes the order in which the the request was relayed to the plurality of user devices of the second user in the forking procedure, in terms of unique identifiers of the user devices, the unique identifier of each of the user devices being supplied by the user device to the proxy server, or being constructed for the user device by the proxy server.

28. The proxy server of claim 24, wherein the proxy server is further configured to insert said information in said responses only when the proxy server observes that said request received from the first user includes a dedicated indicator in a dedicated header.

29. The proxy server of claim 24, wherein said IP network is an IP multimedia subsystem (IMS) network and said proxy server is an S-CSCF server.

30. A user device of a first user of an Internet Protocol (IP) network, the user device configured to execute software to:
issue a request to a second user of said IP network; and
receive a response to said request from at least one user device of the second user that is connected to the IP network; and
take account of at least the following information in the response:
an explicit or implicit indication of a total number of user devices of the second user to which the request was transmitted in a forking procedure; and
an explicit or implicit indication of the number of responses issued so far by one or more user devices of the second user.

31. The user device of claim 30, wherein the information taken into account in a given response also includes the order in which the request was relayed to a plurality of user devices of the second user in terms of parallel forking and/or sequential forking.

32. The user device of claim 31, wherein the information taken into account in a given response also includes the order of the responses issued so far by the user devices of the second user, in terms of parallel forking and/or sequential forking.

33. The user device of claim 31, wherein the information taken into account in a given response also includes the order in which said request was relayed in the forking procedure to a plurality of user devices of the second user, in terms of unique identifiers of the user devices.

34. The user device of claim 30, wherein the user device is further configured to insert in said request a dedicated indicator in a dedicated header, said dedicated indicator indicating that the user device is configured to take account of the information in the response.

35. A stateful server, configured to execute software to, when placed on the signaling path between the user device of a first user and the proxy server in charge of a second user of an IP network:
transfer a request issued by said user device of the first user to said proxy server in charge of the second user; and
transfer to the user device of the first user a plurality of respective responses to said request issued by a plurality of respective user devices of the second user.

36. A system for communication in an Internet Protocol (IP) network, the system comprising:
the proxy server of claim 24; and
a stateful server configured to, when placed on a signaling path between a user device of a first user and the proxy server in charge of a second user of an IP network:
transfer a request issued by said user device of the first user to said proxy server in charge of the second user; and
transfer to the user device of the first user a plurality of respective responses to said request issued by a plurality of respective user devices of the second user.

37. A non-transitory computer readable medium having stored thereon instructions, which when executed by a processor, cause the processor to perform the method of claim 20.

38. A computer having stored thereon instructions, which when executed by the computer, cause the computer to perform the method of claim 1.
